(19) United States
(12) Patent Application Publication
(10) Pub. No.: US 2008/0068455 A1
(43) Pub. Date: Mar. 20, 2008

(54) REAR FACING VIEWING SYSTEM FOR LARGE VEHICLES

(76) Inventor: Richard J. Pratt, Norcross, GA (US)

Correspondence Address: GEORGE R. REARDON, 3356 STATION COURT, LAWRENCVILLE, GA, 30044, US

(21) Appl. No.: 11/533,352

(22) Filed: Sep. 19, 2006

(51) Int. Cl. H04N 7/18

(52) U.S. Cl. 348/118

(57) ABSTRACT

A vehicular viewing system is disclosed that allows a driver following a large vehicle the ability to see in front of the large vehicle. The viewing system may consist of an electronic viewing arrangement, a periscope viewing arrangement or both.

### FIELD OF THE INVENTION

The present invention relates to the field of viewing systems. In particular the present invention is drawn to a viewing system that provides a driver following a large vehicle a view showing what is in front of the large vehicle in order to see the road conditions and/or traffic signals beyond a view-obstructing vehicle, such as a tractor-trailer.

### BACKGROUND OF THE INVENTION

Large vehicles, e.g., tractor-trailers, frustrate following drivers due to the inability of the driver in a following vehicle to see around the tractor-trailer, either while moving, or while stopped in traffic. The large vehicle blocks the following driver's vision of the traffic light in front of the large vehicle, or the traffic further up the highway.

This can cause particular problems for those who believe in defensive driving. If the following driver could see through the taller vehicle in front of him then no problem would exist. Since the following driver is driving “blind” in that the following driver cannot see the roadway beyond the taller vehicle blocking his vision, the following driver must rely on the proper and timely braking of the taller vehicle for warning of road hazards.

One solution to this situation involves the following driving weaving back and forth in an attempt to peer around the taller vehicle. A better solution would be to provide the following driver with a view that is a reasonable facsimile of the view of the driver in the taller vehicle.

While several inventions have provided means for mounting cameras or mirror assemblies on a vehicle to provide better view for the driver of the vehicle with the viewing system, none have provided for placing a viewing system on a large vehicle in order to provide a better view for the driver of a following vehicle, nor for placing a portion of a viewing system on a large vehicle and another portion of a viewing system within the following vehicle.

Related art that addresses the above problems includes the following patents.

U.S. Pat. No. 3,501,218, issued to Zitzelberger on Mar. 17, 1970, discloses a viewing system for vehicles utilizing at least one pylon-type objective lens mounting exteriorly of the vehicle and a related viewing screen within the vehicle, with intermediate light image transmitting means. Manipulative means are accessible within the vehicle to both rotate and to effect an oblique positioning of the objective lens. Motion of the lens in the latter sense is accompanied by an automatic appropriate readjustment of the viewing screen for stable image reflection.

U.S. Pat. No. 3,827,788, issued to Clark on Aug. 6, 1974, discloses a periscope rear vision system for viewing over the roof of a motor vehicle includes three mirrors, one of which is a one-way mirror and two of which are conventional plane mirrors. The one-way mirror located above the roof receives rearward images for redirection upwardly to one of the plane mirrors also located above the vehicle roof. This mirror reflects the images downwardly with partial transmission through the one-way mirror and an opening in the roof to the other plane mirror located in the vehicle interior and redirection therefrom to the driver.

U.S. Pat. No. 4,120,566, issued to Sanci et al. on Oct. 17, 1978, discloses a rearview image projecting apparatus utilizing a pair of rearwardly turned periscopes providing a view from the rear of the vehicle, passing over the roof portions thereof, and thence through the front windshield into a pair of image diverting assemblies so as to cause the pair of projected images to enter, at opposite ends, an image viewing apparatus. The image viewing apparatus utilizes lens means and selective light intensity filter means to combine both images supplied thereto into a single projected image on a viewing screen visibly accessible to the operator of the vehicle.

U.S. Pat. No. 4,968,124, issued to Deckert et al. on Nov. 6, 1990, discloses a vehicle viewing system for use on vehicles to enhance the vehicles' safe operation by minimizing blind spots. The system has an objective assembly mountable on the vehicle with its field of view substantially encompassing a blind spot. The images within the field of view are carried from the objective assembly to a viewer assembly via an image relay system. The image relay system may be a conventional fiber optic cable or a periscope assembly mounted between two fiber optic cables to extend the image transmission. The periscope assembly utilizes a lens assembly to relay images. The viewer assembly is mountable in an easy-to-see location on the vehicle suitable for viewing by the vehicle operator. The objective assembly has a lens system to enable the system to present continuous color images for viewing.

U.S. Pat. No. 6,059,418, issued to Edwards on May 9, 2000, discloses a system of mirrors for a vehicle which augments an operator's vision to allow a clear vision path past a forward obstacle. The operator's vision is reflected backwards by a first mirror. This first mirror is angles towards a second mirror facing forward. The resulting reflection of the second mirror allows the operator to see along side of any obstruction which may be blocking forward vision, such as a larger vehicle.

U.S. Pat. No. 6,384,741 B1, issued to O'Leary, Sr. on May 7, 2002, discloses a camera or fiber optic lens is raised from an automobile on a retractable support to a height sufficient to view over SUVs to perceive an image of traffic beyond an obstructive SUV and transmit the image to a display that is viewable by the driver.

U.S. Pat. No. 6,690,413 B1, issued to Moore on Feb. 10, 2004, discloses a rear viewing system for tractor-trailer vehicles. An automated, universal trailer rear viewing system that is integrated in its entirety on the head or pulling portion of a pivotally connected articulated vehicle is disclosed. The system includes: (a) at least one image capturing device mounted on the tractor designed to tilt, pan and focus on a target object or an area around the trailer; (b) a computer located inside the tractor coupled to the image capturing device; (c) an image capturing and comparative software program loaded into the memory of the computer capable of processing the image file of the target object transmitted from the image capturing device, and capable of generating control commands to the image capturing device so that an image of the target object is maintained as the system is activated; (d) at least one adjustable viewing camera also coupled to the computer that automatically adjusts the viewing camera tilting, panning and focusing according to the movement of the image capturing device; and, (e) at least one display monitor located near the driver that is coupled to the viewing camera so that the image seen thereby may be seen by the driver.

U.S. Pat. No. 7,006,129 B1, issued to McClure on Feb. 28, 2006, discloses a rear-view display system for a vehicle comprising a camera that is disposed near the rear of the vehicle and being generally rearwardly directed. The invention also includes a display that is in the general form and location of a conventional center-mounted rear-view mirror. Namely, the display is located near the top center portion of the windshield of the vehicle. In accordance with the invention, the video image that is captured (e.g., the scene to the rear of the vehicle) is displayed upon the display. By using the invention, a driver is able to view the area behind the vehicle as if the driver were looking into a conventional rear-view mirror.

While these patents and other previous methods have attempted to solve the problems that they addressed, none have utilized or disclosed a viewing system mounted on a large vehicle that allows a following driver to view ahead of the large vehicle, as does embodiments of the present invention, either by the following driver viewing an image display element on the rear of the large vehicle. These patents and other previous methods also have not utilized nor disclosed a viewing system mounted on a large vehicle which transmits an image to an image display element within the following vehicle.

Therefore, a need exists for a rear facing viewing system for large vehicles with these attributes and functionalities. The rear facing viewing system for large vehicles according to embodiments of the invention substantially departs from the conventional concepts and designs of the prior art. It can be appreciated that there exists a continuing need for a new and improved rear facing viewing system for large vehicles which can be used commercially. In this regard, the present invention substantially fulfills these objectives.

The foregoing patent and other information reflect the state of the art of which the inventor is aware and are tendered with a view toward discharging the inventor's acknowledged duty of candor in disclosing information that may be pertinent to the patentability of the present invention. It is respectfully stipulated, however, that the foregoing patent and other information do not teach or render obvious, singly or when considered in combination, the inventor's claimed invention.

### BRIEF SUMMARY OF THE INVENTION

The general purpose of the present invention, which will be described subsequently in greater detail, is to provide a vehicular viewing system. In particular, the present invention relates to a device that allows a driver following a large vehicle the ability to see in front of the large vehicle.

Generally speaking, the present invention permits viewing beyond a large vehicle.

Both periscope systems and camera-monitor systems are well known in the art so the particulars of these systems are not discussed herein.

In one embodiment, the structure and method of fabrication of the viewing system is applicable to a periscope housing affixed to the rear external portion of the trailer portion of a tractor-trailer, permitting a portion of the front view thereof to be shown to a following driver through the periscope mirroring arrangement.

In another embodiment, the structure and method of fabrication of the viewing system is applicable to a camera-monitor arrangement, where the images viewed by the camera are transmitted to the monitor. Typical camera placement may include the top of the cab of a tractor trailer, the side of the cab, the side of the trailer, the front top of the trailer, the rear top of the trailer. Other camera positions may also be used. Typical monitor placement is such that it faces the following driver, e.g. on a rear door of a trailer.

In some embodiments, multiple cameras and/or monitors may be used. In some embodiments the view shown on the monitor may alternate from one camera to another. In some embodiments the monitor may show multiple views simultaneous, e.g. in separate sections of the monitor. The sending of the image from a camera to a monitor may be by wired or wireless transmission. The monitor image may be shown in black and white or color. The monitor image may be shown using infrared or night vision technology.

One aspect of the present invention is that it provides a following driver with a view of traffic beyond an obstructive, oversized vehicle, such as a tractor-trailer.

Another aspect of the present invention is that it provides a following driver with a display of images perceived by electronic viewing means, non-electronic viewing means, or both, sufficient to view over and/or around an obstructive, oversized vehicles.

Another aspect of the present invention is that it may be made from readily available components.

Another aspect of the present invention is that it may be economically manufactured.

These and other features and advantages of the present invention will be presented in more detail in the following specification of the invention and the accompanying figures, which illustrate by way of example the principles of the invention.

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE SEVERAL VIEWS OF THE DRAWINGS

The invention, together with further advantages thereof, may best be understood by reference to the following description taken in conjunction with the accompanying drawings in which:

FIG. 1 illustrates a rear perspective view of a rear facing viewing system for large vehicles, according to an embodiment of the present invention.

FIG. 2 illustrates a front perspective view of a rear facing viewing system for large vehicles, according to an embodiment of the present invention.

FIG. 3 illustrates a rear perspective view of another arrangement of a rear facing viewing system for large vehicles, according to an embodiment of the present invention.

FIG. 4 illustrates a perspective view of an image capturing device, according to an embodiment of the present invention.

FIG. 5 illustrates a perspective view of an image viewing device, according to an embodiment of the present invention.

FIG. 6 illustrates a rear perspective view of an alternate configuration of a rear facing viewing system for large vehicles, according to an embodiment of the present invention.

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known operations have not been described in detail so not to unnecessarily obscure the present invention.

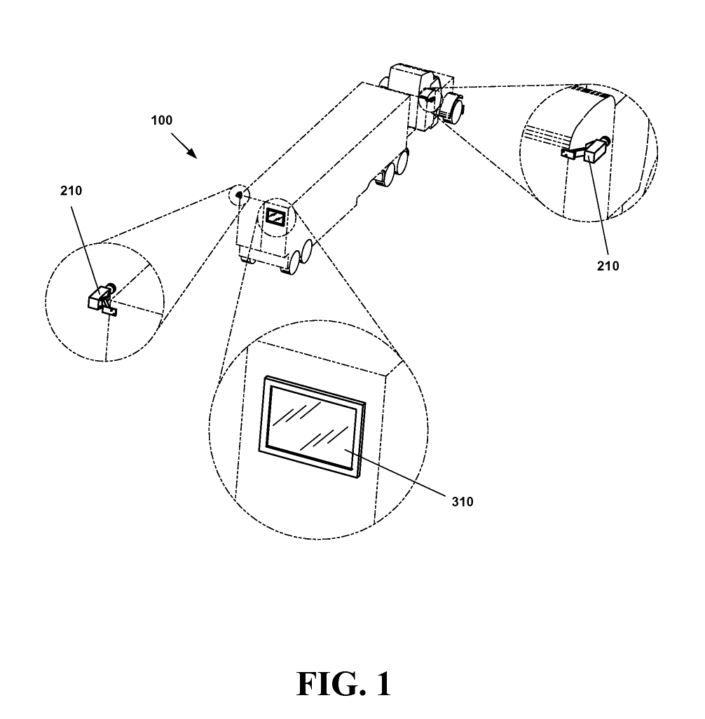

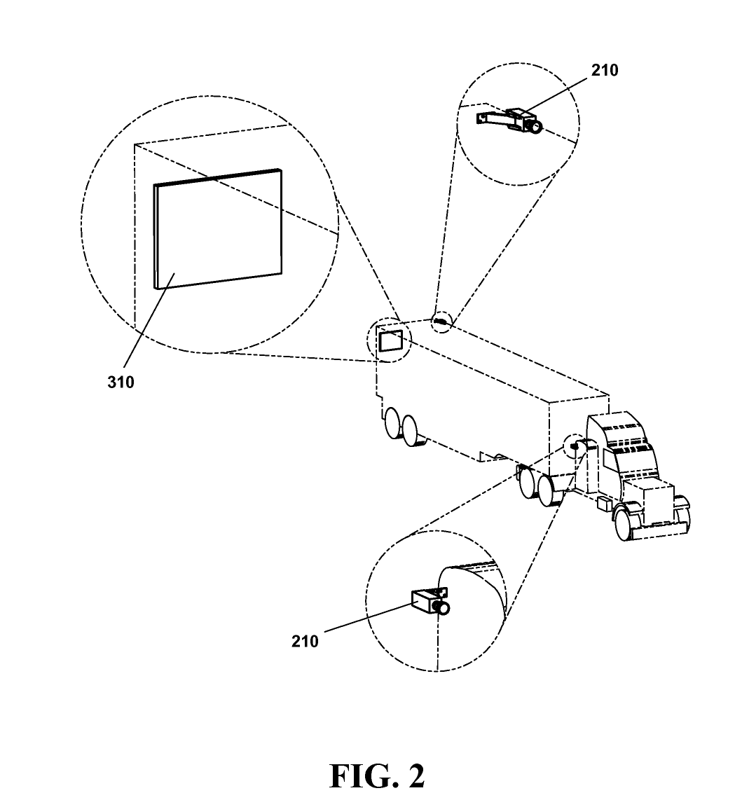

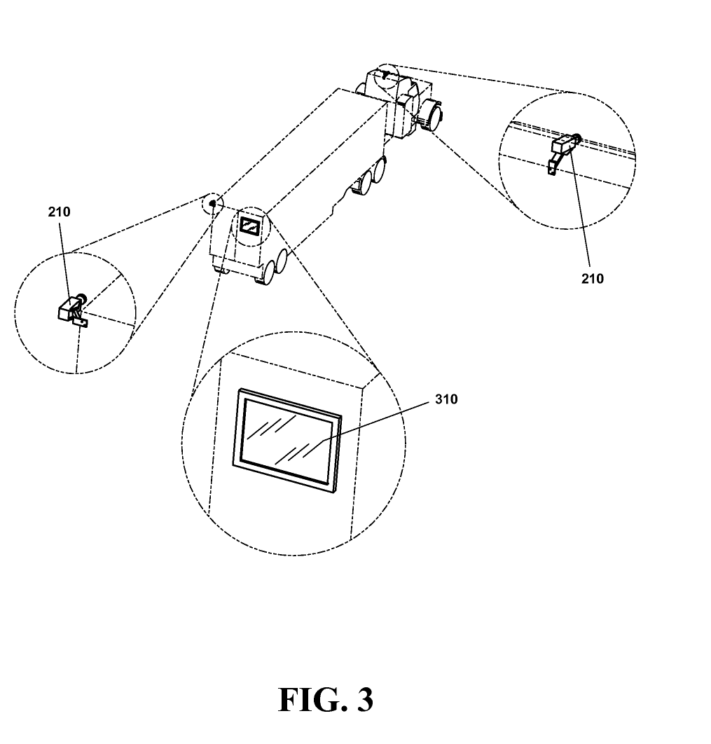

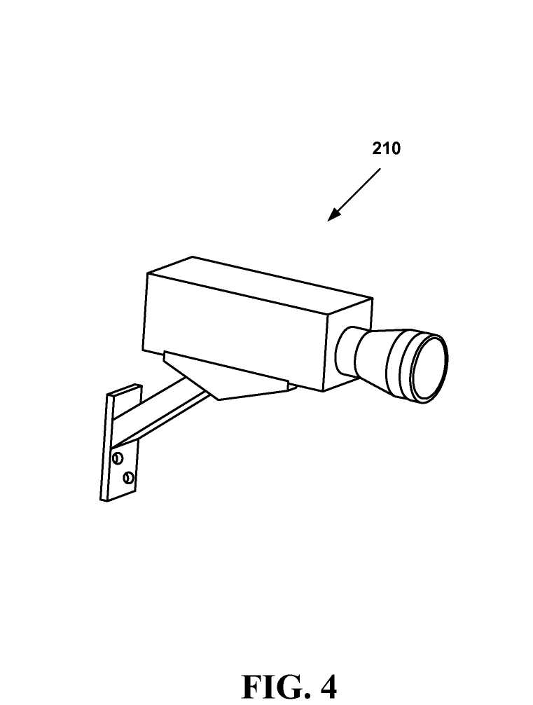

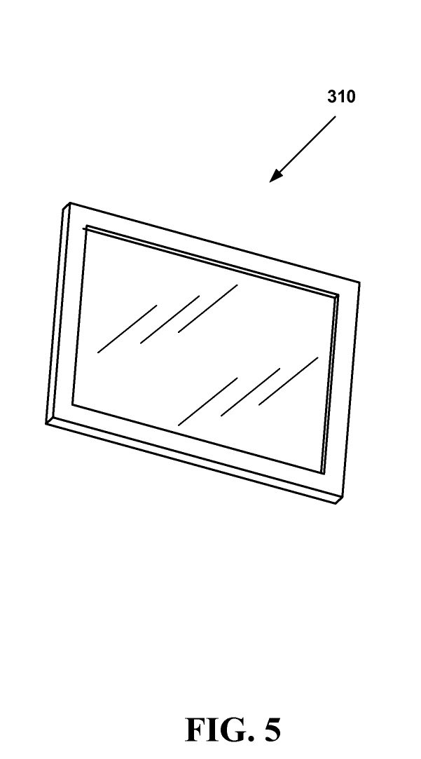

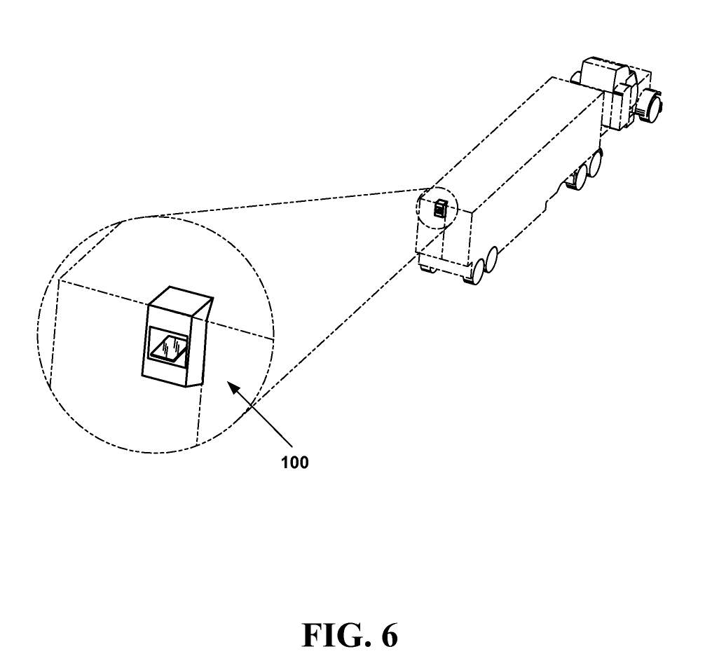

Referring now to FIG. 1 through FIG. 6 a viewing system 100 is comprised of at least one of an image capturing element, at least one of an image displaying element and at least one of an image sending element.

In one embodiment the viewing system 100 relates to a periscope housing mounted on the rear of a trailer, where the mirroring components of the periscope housing are arranged to give a following driver a view of what is in front of the tractor-trailer, e.g. a traffic light immediately in front of the tractor trailer.

In another embodiment, the viewing system 100 relates to a camera system and monitor system arrangement with transmission means providing for images captured by a camera system to be sent to a monitor system. One arrangement may be one camera 210 transmitting to one monitor 310. Another arrangement may be one camera 210 transmitting to a plurality of monitor 310.

Another arrangement may be a plurality of camera 210 transmitting to one monitor 310; in this arrangement the image from each camera 210 may appear on the monitor 310 in rotation, or the image from each camera 210 may appear simultaneously on the monitor 310 in separate sections, e.g. the monitor 310 may segment each image in its own “square”. Another arrangement may be a plurality of camera 210 transmitting to a plurality of monitor 310.

In yet another embodiment, the present invention may be comprised of a combination of a viewing system consisting of a periscope housing arrangement and a viewing system consisting of a camera system and monitor system arrangement with transmission means arrangement. This provides a backup viewing system if one of the viewing systems is inoperable.

In still another embodiment of the present invention, a wireless camera mounted on a large vehicle may transmit a hidden frontal image to a following auto's monitor or driver's video screen, either using a commercially available short-range frequency, e.g. WI-FI, or on a separate frequency made available for this purpose. In this embodiment instead of the transmitted image being displayed on the back of the trailer it may be displayed on the following driver's dashboard monitor.

From the foregoing, it will be appreciated that, although specific embodiments of the invention have been described herein for purposes of illustration, various modifications may be made without deviating from the spirit and scope of the invention. For example, many of the features and components described above in the context of a particular rear facing viewing system for large vehicles configuration can be incorporated into other configurations in accordance with other embodiments of the invention. Accordingly, the invention is not limited except by the appended claims.

What is claimed is:

1. A rear facing viewing system for a large vehicle comprising:
at least one of an image capturing element,
at least one of an image displaying element, and
means for transmitting an image from the at least one image capturing element to the at least one image displaying element, wherein the at least one image displaying element is connected to a rear portion of the large vehicle and facing rearward, and
the at least one image capturing element is connected to the large vehicle and facing forward.

2. The rear facing viewing system of claim 1, wherein the image capturing element, the image displaying element and the means for transmitting an image from the image capturing element are contained within a periscope housing and the image capturing element consists of a first mirror operably positioned above the image displaying element and the image displaying element consists of a second mirror operably positioned below the second mirror.

3. The rear facing viewing system of claim 1, wherein the image capturing element is an electronic image capturing device, the image displaying element is an electronic image displaying device.

4. The rear facing viewing system of claim 3, wherein the means for transmitting consists of a wireless arrangement.

5. The rear facing viewing system of claim 3, wherein the means for transmitting consists of a wired arrangement.

6. A rear facing viewing system for a large vehicle comprising:
at lease one of an electronic imaging system and
at least one of a periscope imaging system, wherein the at least one electronic imaging system consists of at least one electronic display connected to a first area of a rear portion of the large vehicle and facing rearward, and the at least one periscope imaging system is connected to a second area of a rear portion of the large vehicle with a display mirror facing rearward.
